(19) United States
(12) Patent Application Publication
(10) Pub. No.: US 2005/0092798 A1
(43) Pub. Date: May 5, 2005

(54) Clamp and clamp attached article carrier

(76) Inventors: Mark H. Borgman, Windsor, CO (US); Arlo C. Englund, Calhan, CO (US); Gary A. Prommel, Windsor, CO (US)

Correspondence Address: ANCEL W. LEWIS, JR., 425 WEST MULBERRY, SUITE 101, FORT COLLINS, CO, 80521, US

(21) Appl. No.: 10/701,088

(22) Filed: Nov. 4, 2003

(51) Int. Cl. B62J 7/06

(52) U.S. Cl. 224/420

(57) ABSTRACT

An article carrier for attachment to a tube of a bicycle, preferably the handlebar, or other tubular structure has a body and a clamp rotably mounted to the body so that the clamp can be fixed at any angle relative to the body. The clamp has opposed first and second clamp members that wrap around the tube. The first clamp member mounts on the body. The second clamp member is connected by a link member to an eccentric cavity in an actuator that is rotably mounted in the body. The first clamp member has an engagement fingers opposite the body and the second clamp member has an engagement tab with a transverse peg opposite the body that interlocks with the engagement fingers. When the actuator is rotated the eccentric cavity moves away from the first clamp member, pulling the second clamp member inwards and pulling the engagement tab and peg into the engagement fingers to lock the clamp around the tube.

### TECHNICAL FIELD

The present invention relates to clamps and article carriers, and more particularly to a clamps and article carriers for attachment to a bicycle handlebar or other tube.

### Background Art

Article carriers are attached to bicycles when the bicycle rider wishes to transport additional items. Generally, bags are attached to handlebars and racks are attached behind the seat. Most prior known bags and racks are attached with clamps that are secured around a tube, such as the handlebars, seatpost or seat tube, with screws or bolts. Such clamps require time and tools for attachment and removal. In order to minimize bicycle weight and air resistance, it is desirable to have a clamp for such article carriers that firmly grasps the tube and is capable of quick release without tools, to quickly remove the article carrier when not in use.

Bulky and irregularly shaped articles, such as skateboards, can be difficult to attach to and awkward to carry on generic bicycle article carriers. Carriers specifically configured to carry such articles are desirable. Quick removal of such a carrier and/or attachment of a differently configured carrier is also desirable. Many handlebars are curved and it is often desirable to clamp an article carrier to an angled or vertical portion of a handlebar.

### DISCLOSURE OF THE INVENTION

A bicycle attached article carrier includes a body and a clamp. The body is configured for a specific article type and includes a clamp mounting projection. The clamp is rotably attached to the body such that the body can be rotated 360 degrees relative to the body. The clamp has first and second clamp members, a link member and an actuator. The base of the first clamp member mounts around the clamp mounting projection of the body. The base of the second clamp member pivotally mounts on the link member. The actuator has a cylindrical portion that rotably mounts in the body adjacent to the clamp mounting surface and a handle attached to the cylindrical portion. The cylindrical portion includes an eccentric cavity and a circumferentially extending slot extending from the eccentric cavity to the outer surface of the cylindrical portion. The link member extends from the base of the second clamp member through the base of the first clamp member, into the body and through the slot in the cylindrical portion, and has a barrel shaped end that rotably mounts in the eccentric cavity. The first and second clamp members extend from the bases around opposite sides of a tube and have interlocking tips opposite the bases that are pulled into interlocking engagement by the link member when the handle is turned.

### BRIEF DESCRIPTION OF THE DRAWINGS

Details of this invention are described in connection with the accompanying drawings that bear similar reference numerals in which:

FIG. 1 is a rear perspective view of an article carrier embodying features of the present invention.

FIG. 2 is an exploded front perspective view of the carrier of FIG. 1.

FIG. 3 is an enlarged perspective view of the tip of the first clamp member of the carrier of FIG. 1.

FIG. 4 is an enlarged perspective view of the tip of the second clamp member of the carrier of FIG. 1.

FIG. 5 is a perspective view of the actuator of the carrier of FIG. 1.

FIG. 6 is a partial sectional view taken along line 6-6 of FIG. 1 with the clamp open.

FIG. 7 is a side elevation view of the clamp of the carrier of FIG. 1 with the clamp partially closed.

FIG. 8 is a side elevation view of the clamp of the carrier of FIG. 1 with the clamp closed.

FIG. 9 is a perspective view of an alternative article carrier embodying features of the present invention.

### DETAILED DESCRIPTION OF THE INVENTION

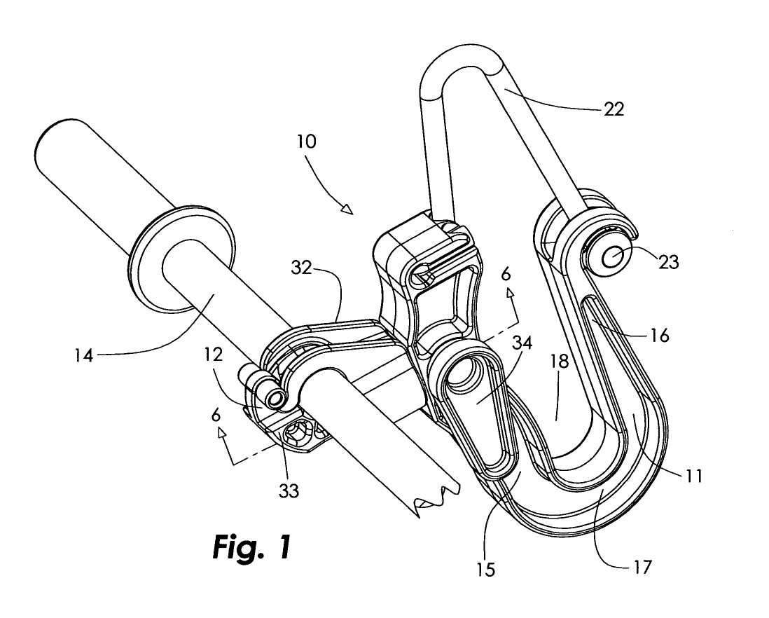

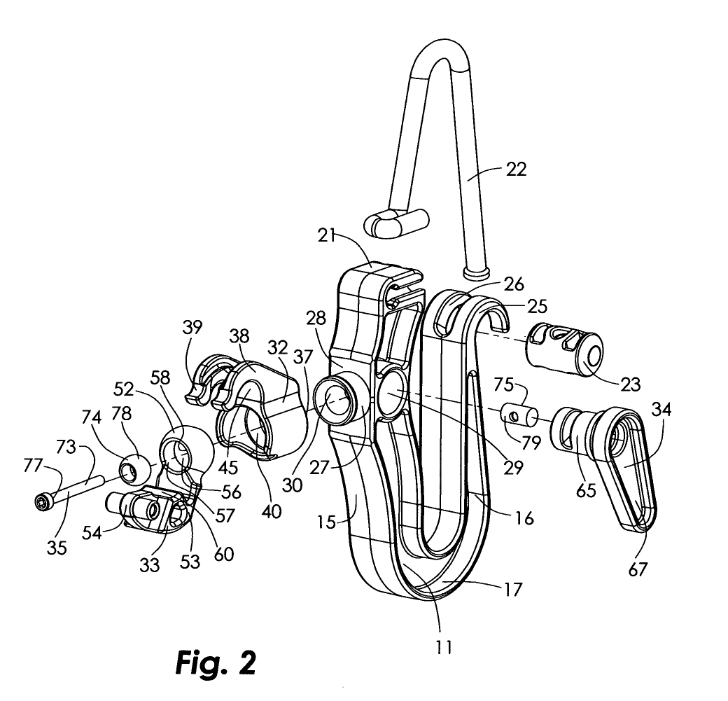

Referring now to FIGS. 1 and 2, an article carrier 10 embodying features of the present invention includes a body 11 and clamp 12. The article carrier 10 in the illustrated embodiment, as shown in FIG. 1, is sized to clamp onto the handlebar 14 of a bicycle and the body 11 is configured to carry a skateboard. Generally, for carrying a skateboard, two laterally spaced article carriers 10 would be used with one article carrier 10 attached to each handlebar 14. The body 11 shown may carry other flat articles. The body 11 may also be configured specifically for carrying other types of articles. Clamp 12 is suitable for clamping around other rigid round tubes.

Describing the specific embodiments herein chosen for illustrating the invention, certain terminology is used which will be recognized as being employed for convenience and having no limiting significance. For example, the terms “front”, “back”, “top”, “bottom” and “side” refer to the illustrated embodiment in its normal position of use. The terms “inward” and “outward” refer to directions toward and away from the geometric center of the apparatus. Further, all of the terminology above-defined includes derivatives of the word specifically mentioned and words of similar import.

The body 11 is generally J shaped with a long leg 15 connected at the bottom to the bottom of a short leg 16 by a curved section 17 to form a groove 18. The groove 18 shown is sized and shaped to receive a skateboard. The top end 21 of the long leg 15 is configured to fixedly hold one end of an elastic cord 22. A knob 23 is attached to the opposite end of the elastic cord 22. The top end 25 of the short leg 16 hooks outward and downward, and is split by a slot 26. The elastic cord 22 is wrapped over the skateboard and through the slot 26 with the knob 23 hooked into the top end 25 of the short leg 16 to secure the skateboard in the body 11.

The long leg 15 has an outwardly extending, cylindrical clamp mounting projection 27, between the curved section 17 and the top end 21. A cylindrical clamp actuator cavity 29 extends laterally through the long leg 15, inward of the clamp mounting projection 27. A cylindrical link member aperture 30 extends through the clamp mounting projection 27 and the long leg 15 to the clamp actuator cavity 29.

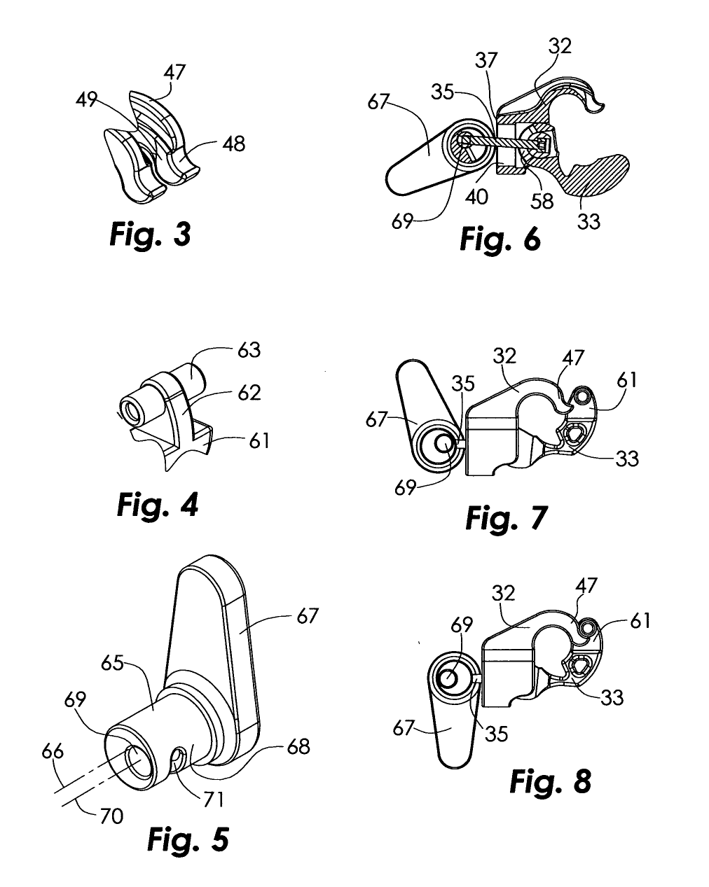

The clamp 12 includes opposed first and second clamp members 32 and 33, an actuator 34 and a link member 35. The first clamp member 32 has a base 37, an intermediate portion 38 that extends outwardly from the base 37, and a tip 39 at the outward end of the intermediate portion 38. A cylindrical clamp mounting aperture 40, sized to fit around the clamp mounting projection 27, extends through the base 37. The intermediate portion 38 of the first clamp member 32 extends upwardly and outwardly, then curves outwardly and downwardly, with an inner surface 45 that is sized and shaped to wrap partially around the handlebars 14. As shown in FIG. 3, the tip 39 has a first interlocking portion 47 in the form of two spaced fingers 48, separated by a notch 49, that curve outwardly from the end of the intermediate portion 38.

Referring again to FIGS. 1 and 2, the second clamp member 33 has a base 52, an intermediate portion 53 that extends outwardly from the base 52, and a tip 54 at the outward end of the intermediate portion 53. The base 52 has an inner end 56 and a spaced, outwardly opening, semi-spherical link member cavity 57 that extends inwardly into the base 52. A vertically elongated link member aperture 58 extends through the base 52 from the link member cavity 57 to the inner end 56. The intermediate portion 53 of the second clamp member 33 extends downwardly and outwardly, then curves outwardly and upwardly, with an inner surface 60 that is sized and shaped to wrap partially around the handlebar 14, opposite the first clamp member 32.

As shown in FIG. 4, the tip 54 has a second interlocking portion 61 in the form of a tab 62 and a peg 63 extending transversely through the tab 62. The tab 62 extends upwardly from the end of the intermediate portion 53 and is sized to fit into the notch 49 of the first interlocking portion 47. The peg 63 is spaced from the end of the intermediate portion 53 such that the fingers 48 of the first interlocking portion 47 fit between the peg 63 and the end of the intermediate portion 53. The distance from the tab 62 of the tip 54 to the inner end 56 of the base 52 of the second clamp member 33 is selected to be slightly less than the distance from the notch 49 of the tip 39 to the outer face 42 of the base 37 of the first clamp member 32.

Referring to FIG. 5, the actuator 34 has a cylindrical portion 65 that rotably mounts about a first axis 66 in the clamp actuator cavity 29 of the body 11 and a handle 67 that attaches an end of the cylindrical portion 65 and extends transversely therefrom. The cylindrical portion 65 has an outer surface 68 and a cylindrical eccentric cavity 69 extends laterally through the cylindrical portion 65, having a center second axis 70 spaced a selected distance from the first axis 66. In the illustrated embodiment the eccentric cavity 69 is about 90 degrees counterclockwise from the handle 67 when viewed with the handle 67 behind the cylindrical portion 65 or about 90 degrees clockwise from the handle 67 when viewed with the cylindrical portion 65 behind the handle 67. A radial slot 71, connecting the eccentric cavity 69 to the outer surface 68, extends around the cylindrical portion 65 from about the point where the eccentric cavity 69 is nearest to the outer surface 68 slightly over 180 degrees to beyond the point where the eccentric cavity 69 is farthest from the outer surface 68.

The link member 35, as shown in FIG. 2, has an elongated, cylindrical intermediate portion 73, a spherical first end 74 attached to the intermediate portion 73, and a spaced cylindrical second end 75 attached transversely to the intermediate portion 73 opposite the first end 74. The first end 74 is sized and shaped to fit into the link member cavity 57 of the second clamp member 33. The second end 75 is sized and shaped to fit into the eccentric cavity 69 of the cylindrical portion 65 of the actuator 34. In the illustrated embodiment the intermediate portion 73 is an allen head screw 77, the first end 74 is a spherical retainer 78 that receives the head of the screw 77, and the second end 75 is a barrel nut 79 removable from the screw 77.

The clamp 12 is assembled with the clamp mounting aperture 40 of the base 37 of the first clamp member 32 over the clamp mounting projection 27 on the long leg 15 of the body 11 and the cylindrical portion 65 of the actuator 34 in the clamp actuator cavity 29 of the body 11. The first end 74 of the link member 35 is assembled into the link member cavity 57 of the second clamp member 33 with the intermediate portion 73 of the link member 35 between the base tabs 56. The intermediate portion 73 of the link member 35 extends through the link member aperture 58 of the second clamp member 33, the base 37 of the first clamp member 32 and the link member aperture 30 of the long leg 15 of the body 11. The second end 75 of the link member 35 is assembled into the eccentric cavity 69 of the cylindrical portion 65 of the actuator 34.

Referring to FIG. 6, when the actuator 34 is turned such that the eccentric cavity 69 is nearest to the clamp mounting surface 28 of the long leg 15 of the body 11, the second clamp member 33 is released from the first clamp member 32 and can rotate downwards. To clamp the carrier 10 onto the handlebar 14, the inner surface 45 of the intermediate portion 38 of the first clamp member 32 is positioned on the handlebar 14. The second clamp member 33 is rotated upwards so that the inner surface 60 of the intermediate portion 53 of the second clamp member 33 is positioned against the handlebar 14, as shown in FIG. 7. Referring to FIG. 8, the handle 67 of the actuator 34 is rotated so that the eccentric cavity 69 moves away from the clamp mounting surface 28 of the long leg 15 of the body 11, pulling the link member 35 inwards. The link member 35 pulls the base 52 of the second clamp member 33 towards the base 37 of the first clamp member 32. The link member 35 thereby pulls the first and second interlocking portions 47 and 61 into interlocking engagement, with the tab 62 on the tip 54 of the second clamp member 33 in the notch 49 on the tip 39 of the first clamp member 32, and the fingers 48 on the tip 39 of the first clamp member 32 between the peg 63 on the tip 54 and the end of the intermediate portion 53 of the second clamp member 33.

When the clamp 12 is clamped, with the first and second interlocking portions 47 and 61 engaged, the second clamp member 33 hinges slightly at the tip 54 relative to the first clamp member and the tension on the second clamp member 33 from the pull by the link member 35 causes the intermediate portions 38 and 53 of the first and second clamp members 32 and 33 to squeeze together and firmly grasp the handlebar 14.

When the clamp 12 is clamped, with the first and second interlocking portions 47 and 61 engaged, the tension on the second clamp member 33 from the pull by the link member 35 pulls the base 37 of the first clamp member 32 against the body 11, so that the body 11 is prevented from rotating relative to the clamp 12. When the actuator 34 is turned to release the tension of the link member 35, the first clamp member 32, and thereby the clamp 12, rotates freely relative to the body 11. By way of example, and not as a limitation, other interfaces between the body 11 and the clamp 12, such as a clamp mounting projection on the body 11 that fits into a recess in base 37 of the first clamp member 32, may be provided to prevent rotation of the body 11 relative to the clamp 12 when the clamp 12 is clamped, and allow rotation when the clamp 12 is unclamped.

The first and second interlocking portions 47 and 61, shown as the fingers 48 and the peg 63, when engaged, prevent the second clamp member 33 from moving downwardly or laterally relative to the first clamp member 32. The first and second interlocking portions 47 and 61 can take other forms. By way of example, and not as a limitation, the first and second interlocking portions 47 and 61 can be a recess and tab, or a round, polyhedral or irregular hole and an interfitting peg.

The article carrier 10 described and shown in the Figures can be quickly and easily attached or released from a substantially rigid tube without the use of tools. Although the article carrier 10 is described and shown with a substantially vertical body 11, the clamp 12 can clamp the body 11 at any angle on a round tube. The body 11 can be rotated relative to the clamp 12 so that clamp 12 can be clamped onto a vertical or horizontal tube, a curved tube or a tube at any angle and the article can be carried at any desired angle.

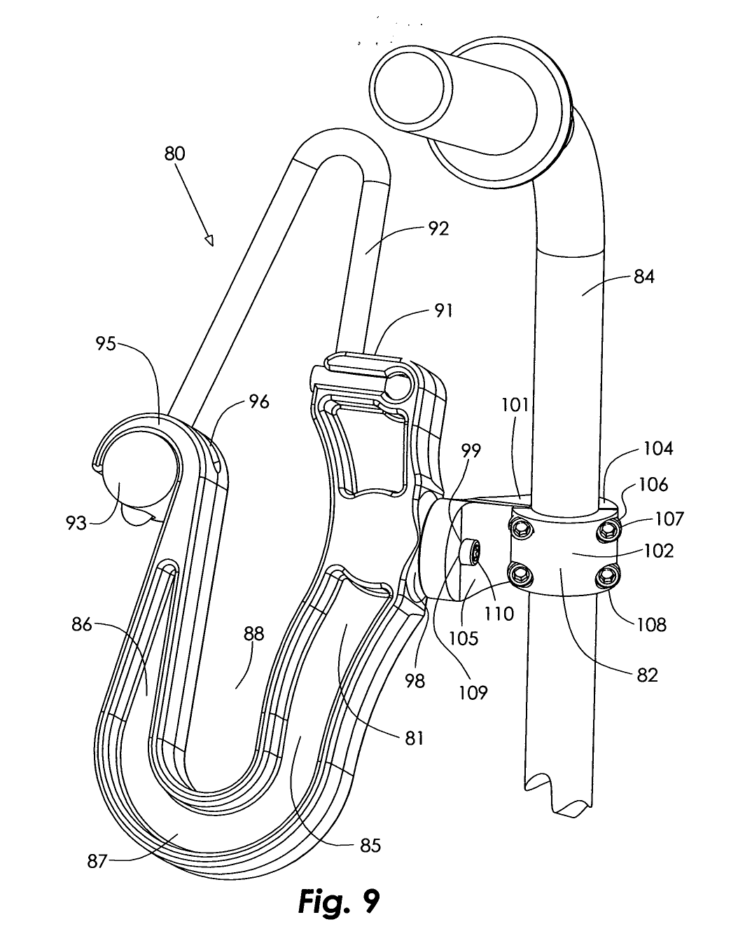

Referring to FIG. 9, an alternative article carrier 80 embodying features of the present invention includes a body 81 and clamp 82 for clamping onto a handlebar 84. The body 81 is generally J shaped with a long leg 85 connected at the bottom to the bottom of a short leg 86 by a curved section 87 to form a groove 88. The groove 88 shown is sized and shaped to receive a skateboard. The top end 91 of the long leg 85 is configured to fixedly hold one end of an elastic cord 92. A knob 93 is attached to the opposite end of the elastic cord 92. The top end 95 of the short leg 86 hooks outward and downward, and is split by a slot 96. The elastic cord 92 is wrapped over the skateboard and through the slot 96 with the knob 93 hooked into the top end 95 of the short leg 86 to secure the skateboard in the body 81. The long leg 85 has a substantially flat, outwardly facing clamp mounting surface 98 between the curved section 87 and the top end 91. An internally threaded first body mounting aperture 99 extends into the long leg 85 from the clamp mounting surface 98.

The clamp 82 has a first clamp member 101 and a second clamp member 102. The first clamp member 101 has a first section 104 sized and shaped to wrap partially around the handlebar 84 and a second section 105 that extends from an end of the first section 104. The first section 104 includes two spaced, internally threaded first clamp apertures 106 at each end. The second clamp member 102 is sized and shaped to wrap partially around the handlebar 84, opposite the first section 104 of the first clamp member 101, and includes two spaced, unthreaded second clamp apertures 107 at each end that align with the first clamp apertures 106. Four clamp fixing bolts 108 extend through the second clamp apertures 107 and thread into the first clamp apertures 106 to secure the clamp 82 to the handlebar 84. A second body mounting aperture 109 extends through the second section 105 of the first clamp member 101, and a body fixing bolt 110 through the second body mounting aperture 109 and threaded into the first body mounting aperture 99 secures the body 81 to the clamp 82. When the body fixing bolt 110 is loosened, the body 81 can be rotated to any angle relative to the clamp 82 to allow mounting of the article carrier 80 on a handlebar 84 of any angle.

Although the present invention has been described with a certain degree of particularity, it is understood that the present disclosure has been made by way of example and that changes in details of structure may be made without departing from the spirit thereof.

1. An article carrier for attachment around a tube comprising:
a body configured to carry an article,
a clamp rotably attached to said body and including means for fixing said clamp in place relative to said body.

2. The carrier as set forth in claim 1 wherein said clamp includes:
a first clamp member having a first base mounted on said body, a first tip opposite said base, and a first intermediate section between said first base and said first tip, said first intermediate section being sized and shaped to wrap partially around said tube, said first tip having a first interlocking portion,
a second clamp member opposite said first clamp member having a second base, a second tip opposite said second base, and a second intermediate section between said second base and said second tip, said second intermediate section being sized and shaped to wrap partially around said tube opposite said first intermediate section, said second tip having a second interlocking portion sized and shaped to interlock with said first interlocking portion,
a link member connected to said second base and extending through said first base, and
an actuator, connected to said link member, that moves said link member when actuated, whereby said link member moves said second base toward said first base and thereby moves said second interlocking portion into interlocking engagement with first interlocking portion to clamp said first and second clamp members around said tube, and when actuated in the opposite direction releases said second interlocking portion from engagement with first interlocking portion.

3. The carrier as set forth in claim 2 wherein:
said second base has an inner end, an outwardly opening semi-spherical cavity, and an elongated link member aperture extending between said semi-spherical cavity and said inner end, and
said link member includes an elongated intermediate portion and a spherical first end attached to said intermediate portion, said first end being mounted in said semi-spherical cavity and said intermediate portion extending through said link member aperture of said base of said second clamp member,
whereby said second clamp member can rotate toward and away from said first clamp member when said first and second interlocking portions are disengaged.

4. The carrier as set forth in claim 3 wherein:
said actuator includes a cylindrical portion rotably mounted in said body and a handle attached to an end of said cylindrical portion and extending transversely therefrom, said cylindrical portion having an outer surface, a cylindrical eccentric cavity and a slot between said outer surface and said eccentric cavity that extends around a portion of said cylindrical portion, and
said link member includes a spaced cylindrical second end attached transversely to said intermediate portion opposite said first end, with said intermediate portion extending through said first base, said body and said slot, and said second end being rotably mounted in said eccentric cavity,
whereby rotating said handle moves said link member and said link member moves said second base toward said first base and thereby pulls said second interlocking portion into interlocking engagement with said first interlocking portion.

5. The carrier as set forth in claim 1 wherein said first interlocking portion includes an outwardly projecting pair of fingers separated by a notch, and said second interlocking portion includes a transversely projecting tab sized to fit into said notch and a peg that extends laterally through said tab and laterally in both directions therefrom, said peg being spaced from said second intermediate section such that said fingers fit therebetween.

6. The carrier as set forth in claim 1 wherein said body is configured to carry a skateboard.

7. The carrier as set forth in claim 6 wherein:
said body is generally J shaped, having a long leg and a spaced short leg connected to said long leg by a curved section to form a groove sized and shaped to receive said skateboard, said long leg having an outer surface and
said first base mounts on said outer surface of said long leg.

8. The carrier as set forth in claim 7 including an elastic cord,
wherein said long leg has a top end configured to fixedly hold an end of said elastic cord,
said elastic cord has a knob opposite said top end of said long leg, and
said short leg has an outwardly and downwardly curved top end and an open slot that splits said top end,
whereby said elastic cord is wrapped over said skateboard and through said slot with said knob hooking into said top end of said short leg to secure said skateboard in said groove.

9. An article carrier for attachment around a tube comprising:
a body configured to carry an article,
a first clamp member rotably mounted on said body and including means for fixing said first clamp member in place relative to said body, said first clamp member having a first base mounted on said body, a first tip opposite said first base, and a first intermediate section between said first base and said first tip, said first intermediate section being sized and shaped to wrap partially around said tube, said first tip having an outwardly projecting pair of fingers separated by a notch,
a second clamp member opposite said first clamp member having a second base, a second tip opposite said second base, and a second intermediate section between said second base and said second tip, said intermediate second section being sized and shaped to wrap partially around said tube opposite said first intermediate section, said second base having a having an inner end, an outwardly opening semi-spherical cavity, and an elongated link member aperture extending between said semi-spherical cavity and said inner end, said second tip having a transversely projecting tab sized to fit into said notch and a peg that extends laterally through said tab and laterally in both directions therefrom, said peg being spaced from said second intermediate section such that said fingers fit therebetween,
a link member having an elongated intermediate portion, a spherical first end attached to said intermediate portion and a cylindrical second end attached transversely to said intermediate portion opposite said first end, said first end being mounted in said semi-spherical cavity of said second base with said intermediate portion extending through said link member aperture of said second base, and said intermediate portion extending through said first base and into said body, and
an actuator having a cylindrical portion rotably mounted in said body adjacent to said first clamp member, and a handle attached to an end of said cylindrical portion and extending transversely therefrom, said cylindrical portion having an outer surface, a cylindrical eccentric cavity and a slot between said outer surface and said eccentric cavity that extends around a portion of said cylindrical portion, said intermediate portion of said link member extending through said slot with said second end of said link member being rotably mounted in said eccentric cavity,
whereby rotating said handle moves said eccentric cavity away from said first clamp member which moves said link member which moves said second base towards said first base and thereby moves said peg into interlocking engagement with said fingers to clamp said first and second clamp members around said tube.

10. A clamp for attachment to a tube comprising:
a first clamp member having a first base, a first tip opposite said first base, and a first intermediate section between said first base and said first tip, said first intermediate section being sized and shaped to wrap partially around said tube, said first tip having a first interlocking portion,
a second clamp member opposite said first clamp member having a second base, a second tip opposite said second base, and a second intermediate section between said second base and said second tip, said second intermediate section being sized and shaped to wrap partially around said tube opposite said first intermediate section, said second tip having a second interlocking portion sized and shaped to interlock with first interlocking portion,
a link member connected to said second base and extending through said first base, and
an actuator, connected to said link member, that moves said link member when actuated, whereby said link member moves said second base toward said first base and thereby moves said second interlocking portion into interlocking engagement with first interlocking portion to lock said first and second clamp members around said tube.

11. The clamp as set forth in claim 10 wherein:
said second base has an inner end, an outwardly opening semi-spherical cavity, and an elongated link member aperture extending between said semi-spherical cavity and said inner end, and
said link member includes an elongated intermediate portion and a spherical first end attached to said intermediate portion, said first end being mounted in said semi-spherical cavity and said intermediate portion extending through said link member aperture of said second base,
whereby said second clamp member can rotate toward and away from said first clamp member when said first and second interlocking portions are disengaged.

12. The clamp as set forth in claim 11 wherein:
said actuator includes a cylindrical portion rotably mounted adjacent to said first base and a handle attached to an end of said cylindrical portion and extending transversely therefrom, said cylindrical portion having an outer surface, a cylindrical eccentric cavity and a slot between said outer surface and said eccentric cavity that extends around a portion of said cylindrical portion, and
said link member includes a spaced cylindrical second end attached transversely to said intermediate portion opposite said first end, with said intermediate portion extending through said first base and said slot, and said second end being rotably mounted in said eccentric cavity, and
whereby rotating said handle moves said link member and said link member moves said second base toward said first base and thereby moves said second interlocking portion into interlocking engagement with said first interlocking portion.

13. The clamp as set forth in claim 10 wherein said first interlocking portion includes an outwardly projecting pair of fingers separated by a notch, and said second interlocking portion includes a transversely projecting tab sized to fit into said notch and a peg that extends laterally through said tab and laterally in both directions therefrom, said peg being spaced from said second intermediate section such that said fingers fit therebetween.
